(19) United States
(12) Patent Application Publication
(10) Pub. No.: US 2025/0355745 A1
(43) Pub. Date: Nov. 20, 2025

(54) ALERT SIGNALING IN MEMORY SYSTEMS

(71) Applicant: Micron Technology, Inc., Boise, ID (US)

(72) Inventor: Scott E. Schaefer, Boise, ID (US)

(21) Appl. No.: 19/182,522

(22) Filed: Apr. 17, 2025

Related U.S. Application Data
(60) Provisional application No. 63/648,574, filed on May 16, 2024.

(51) Int. Cl. G06F 11/07

(52) U.S. Cl. CPC G06F 11/0772; G06F 11/0727; G06F 11/0757

(57) ABSTRACT

Methods, systems, and devices for alert signaling in memory systems are described. A memory system may maintain a first mode register that includes multiple operands, where each operand corresponds to a respective fault that may occur in the memory system. The memory system may also maintain a second mode register that is associated with the first mode register, where each operand of the second mode register corresponds to one or more operands of the first mode register. A value of each operand of the second mode register may indicate whether the memory system is to drive the alert output in response to detection of the corresponding fault. As such, if a first operand of the first mode register is set, indicating a fault has occurred, and a first operand of the second mode register indicates for the alert output to be driven, the memory system may drive the alert output.

### CROSS REFERENCE

The present application for patent claims priority to U.S. Patent Application No. 63/648,574 by Schaefer, entitled “ALERT SIGNALING IN MEMORY SYSTEMS,” filed May 16, 2024, which is assigned to the assignee hereof, and which is expressly incorporated by reference in its entirety herein.

### TECHNICAL FIELD

The following relates to one or more systems for memory, including alert signaling in memory systems.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports alert signaling in memory systems in accordance with examples as disclosed herein.

FIG. 2 shows an example of a circuit diagram that supports alert signaling in memory systems in accordance with examples as disclosed herein.

FIG. 3 shows an example of a circuit diagram that supports alert signaling in memory systems in accordance with examples as disclosed herein.

FIG. 4 shows an example of a process flow that supports alert signaling in memory systems in accordance with examples as disclosed herein.

FIG. 5 shows a block diagram of a memory system that supports alert signaling in memory systems in accordance with examples as disclosed herein.

FIG. 6 shows a flowchart illustrating a method or methods that support alert signaling in memory systems in accordance with examples as disclosed herein.

### DETAILED DESCRIPTION

A memory system may be configured to drive an alert in response to detecting that one or more faults have occurred in the memory system. To support such functionality, the memory system may maintain (e.g., store, operate, or manage) a mode register (e.g., a fault mode register) that includes one or more operands (e.g., bits), each corresponding to a respective fault that may occur in the memory system, where such operands may indicate whether the corresponding fault has been detected and therefore whether the memory system may output an alert. For example, a first mode register may include one or more operands corresponding to each fault, where each operand may be set to a default value (e.g., ‘0’, or low value) until a fault is detected. The memory system may set each operand to a first value (e.g., ‘1’ or high value) if the memory system detects the corresponding fault. In some examples, the memory system may include circuitry (e.g., an OR gate) configured to drive an alert in response to any faults listed in the first mode register being detected (e.g., if any operands of the first mode register are set to the high value). In some examples, a user (e.g., via a host system) of the memory system may desire to select one or more faults for which alerts should be driven (e.g., and one or more faults for which alerts should not be driven). Thus, techniques may be desired to enable the user to select which alerts should be driven in response to detection of a fault in the memory system.

The techniques described herein may enable the user to select which faults the memory system result in an alert output being driven. For example, in addition to maintaining the first mode register (e.g., including the operands, each corresponding to a respective fault), the memory system may maintain a second mode register that includes operands (e.g., bits or entries). An operand of the second mode register may correspond to a one or more operands of the first mode register (e.g., corresponding to a respective fault of the memory system). Accordingly, a host system (e.g., user) may write values (e.g., ‘0’ or ‘1’) to each of the operands in the second mode register, where a default value (e.g., ‘0’) may indicate for the memory system to refrain from driving an alert in response to detection of the corresponding fault and a first value (e.g., ‘1’) may indicate for the memory system to drive an alert in response to detection of the corresponding fault.

Accordingly, if the memory system detects a fault, the memory system may set a corresponding operand in the first mode register to the first value (e.g., ‘1’), thereby indicating that the fault has been detected. In response to, or in conjunction with, setting the corresponding operand in the first mode register, the memory system may determine a value of an operand in the second mode register, where the operand of the second mode register and the operand of the first mode register may correspond to the detected fault. As such, if the value of the operand of the second mode register indicates for the memory system to drive an alert output (e.g., the value is a ‘1’), the memory system may drive the alert output in response to detecting the fault and setting the operand of the first mode register to the first value. Alternatively, if the value of the operand of the second mode register indicates for the memory system to refrain from driving the alert output (e.g., the value is a ‘0’), the memory system may refrain from driving the alert output in response to detecting the fault and setting the operand of the first mode register to the first value.

In addition to applicability in memory systems as described herein, techniques for alert signaling in memory systems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by enabling a user to select one or more faults which may result in an alert output, which may increase user experience by preventing unwanted alerts and decreasing a quantity of read commands used to determine which faults may have resulted in an alert being driven, among other benefits.

Features of the disclosure are illustrated and described in the context of systems and architectures. Features of the disclosure are further illustrated and described in the context of circuit diagrams, block diagrams, and flowcharts.

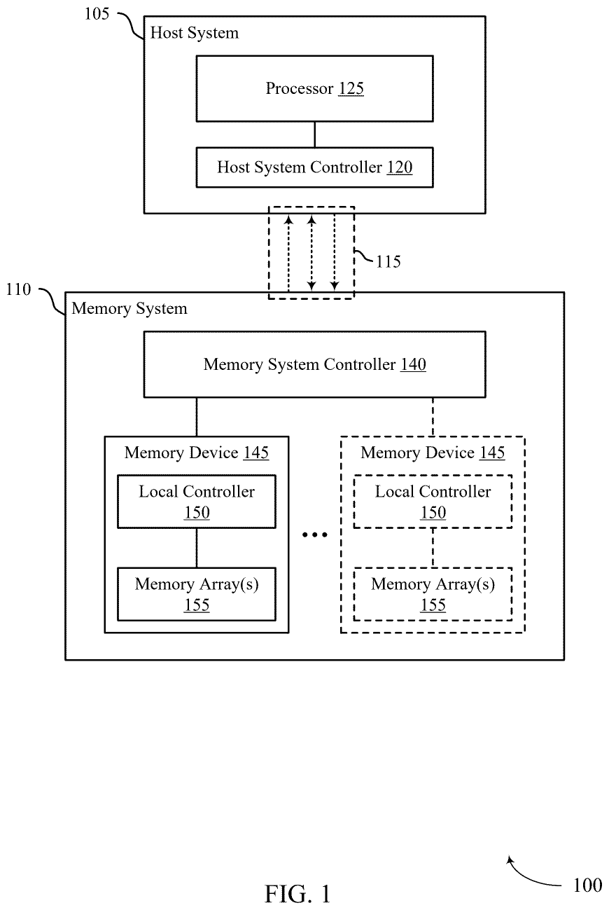

FIG. 1 illustrates an example of a system 100 that supports alert signaling in memory systems in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some examples, a memory system 110 may include a first mode register (e.g., a fault mode register) with operands (e.g., entries) each corresponding to a respective fault that may occur in the memory system 110. In such examples, the memory system may designate (e.g., reserve) the operands of the first mode register as a read-only, such that, in response to a fault, the host system 105 may read the operands of the first mode register to identify which fault has been detected by the memory system 110.

In some aspects, the memory system 110 may include a second mode register with operands that correspond to the operands of the first mode register. In such examples, the memory system 110 may designate (e.g., reserve) the operands of the second mode register as write-only, such that the host system 105 (e.g., the user) may write values to each operand of the second mode register. As described herein, the memory system 110 may utilize the first mode register to monitor (e.g., keep track) of faults that have occurred in the memory system 110, and utilize the second mode register to determine whether to drive an alert output in response to the faults occurring in the memory system. For example, if the memory system 110 identifies a first fault, the memory system 110 may set a first operand of the first mode register to a high value, thereby indicating that the first fault has occurred in the memory system 110. The memory system 110 may determine whether to drive the alert output based on a value of a first operand of the second mode register, where the first operand of the second mode register corresponds to the first operand of the first mode register (e.g., corresponds to the first fault). As such, the memory system 110 may drive the alert output in response to the first operand of both mode registers being set to a high value (e.g., ‘1’). In this way, by maintaining the second mode register, the host system 105 (e.g., the user) may select which faults trigger an alert output from the memory system 110.

In some examples, the faults monitored by the memory system 110 may include a per row activation counting (PRAC) fault, a write link error correction code (ECC) multi-bit error (MBE) fault, a write link error detection code (EDC) single bit error (SBE) fault, a write link EDC MBE fault, a write link ECC SBE attempt fault, an on-die ECC MBE fault, an on-die error correction and scrub (ECS) SBE threshold fault, a command address (CMD/ADDR) parity fault, a refresh rate change, or a combination thereof.

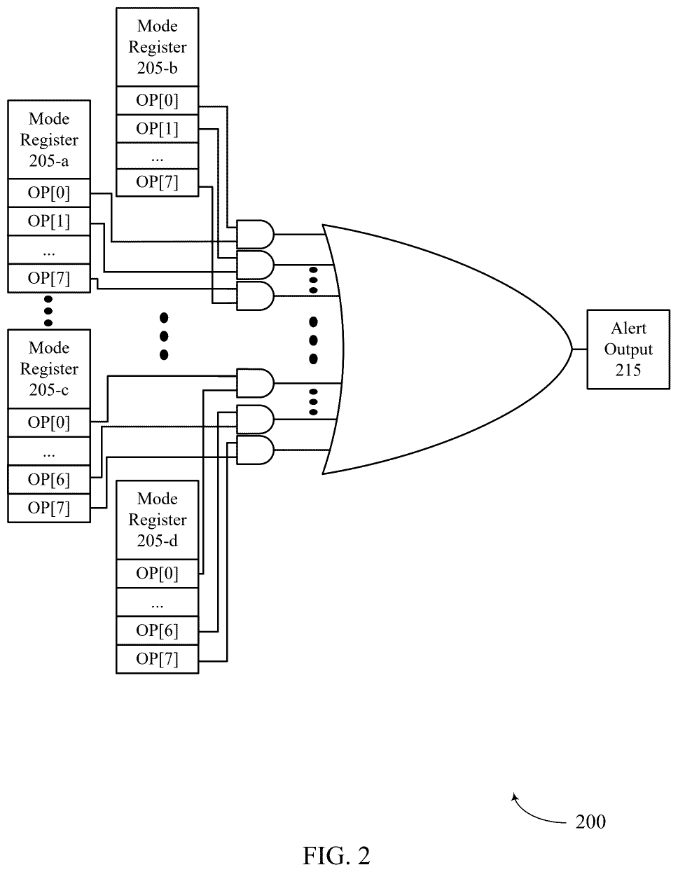

FIG. 2 shows an example of a circuit diagram 200 that supports alert signaling in memory systems in accordance with examples as disclosed herein. The circuit diagram 200 may implement or may be implemented by aspects of the system 100. For example, the circuit diagram 200 may be implemented in the memory system 110 as described with reference to FIG. 1. The techniques described in the context of the circuit diagram 200 may enable a user, via the host system 105, to select which faults drive an alert output 215.

A memory system 110 may be configured to drive the alert output 215 in response to detecting one or more faults in the memory system 110, where the memory system 110 may maintain one or more mode registers 205 (e.g., a fault mode register) to track such faults. For example, the memory system 110 may maintain a mode register 205-a that includes a set of functions each corresponding to a respective fault. For each function (e.g., fault) tracked by the mode register 205-a, the memory system 110 may maintain a respective operand (e.g., bit), which may be set to a default value (e.g., 0 or a low value), and updated to a high value (e.g., 1) when the corresponding fault is detected by the covered function. That is, operands of the mode register 205-a may assume two values, a low value (e.g., ‘0’ or default value) and a high value (e.g., ‘1’), where the values of the operands may remain low unless a covered function has detected a fault, at which point the memory system 110 may set the associated operand (e.g., register bit) to the high value (e.g., or vice-versa).

In some examples, the memory system 110 may designate (e.g., set the type of) the mode register 205-a as read-only (R). That is, the host system 105 may be unable to write values to the operands of the mode register 205-a, and instead are set by the memory system 110 based on whether the corresponding fault (e.g., function) is detected. In such examples, the memory system 110 may receive a mode register read (MRR) command from the host system 105 to read the values of one or more operands of the mode register 205-a. In some examples, when the memory system 110 sets the values of the operands of the mode register 205-a to the high value, the values may remain high (e.g., retain the fault status) until the memory system 110 receives a MRR command from the host system 105 (e.g., the mode register 205-a is read from), until the memory system 110 receives a reset command, until a power source of the memory system 110 is removed, until expiration of timer (e.g., a clock delay or offset from the detection of the fault), or a combination thereof, at which point the values may be reset to the default values (e.g., low). Table 1 provides an illustrative example of the mode register 205-a (e.g., a fault mode register).

TABLE 1

| | Register | | |
|---|---|---|---|
| Function | Type | Operand | Data |
| PRAC limit exceeded | Read | OP[0] | 0_{B}: Fault not detected |
| | | | 1_{B}: Fault Detected |
| Write link ECC MBE fault/Write | Read | OP[1] | 0_{B}: Fault not detected |
| link EDC SBE/MBE fault | | | 1_{B}: Fault Detected |
| Write link ECC SBE correction | Read | OP[2] | 0_{B}: Fault not detected |
| attempted | | | 1_{B}: Fault Detected |
| On-die ECC MBE fault | Read | OP[3] | 0_{B}: Fault not detected |
| | | | 1_{B}: Fault Detected |
| On-die ECC ECS SBE threshold | Read | OP[4] | 0_{B}: Fault not detected |
| exceeded | | | 1_{B}: Fault Detected |
| CMD/ADDR parity fault | Read | OP[5] | 0_{B}: Fault not detected |
| | | | 1_{B}: Fault Detected |
| MR4 refresh rate change | Read | OP[6] | 0_{B}: Fault not detected |
| detected | | | 1_{B}: Fault Detected |
| Sum of Mode Register X | Read | OP[7] | 0_{B}: Fault not detected |
| OP[7:0] | | | 1_{B}: Fault Detected |

As described herein, the memory system 110 may track (e.g., monitor) various faults that may occur in the memory system 110 via the mode register 205-a. For example, the memory system 110 may track, via OP[0] of the mode register 205-a, where a PRAC limit exceeded fault has occurred. The PRAC limit may indicate that a row address of a memory device 145 has been activated more than a threshold quantity of times (e.g., that a PRAC limit has been exceeded). For example, the memory system 110 may detect activity that may adversely affect the data stored in cells on physically adjacent rows within the memory devices 145. As one or more rows' activation counts approach or reach a maximum activation threshold after a Refresh (REF) or Refresh Management (RFM) command, the host system 105 and the memory system 110 (or memory devices 145) may take action to prevent data in affected cells from flipping states. Accordingly, to account for the activation counts of each row, the memory system 110 may implement the PRAC function to add activation counter bits to each row of memory cells within the memory system 110, where such bits may store a count associated with the quantity of received activations for a row of memory cells since the last time a refresh operation was performed at the row. In such examples, activations to a row may include an activation, REF, RFM commands, or a combination thereof.

Additionally, the memory system 110 may track, via OP[1] of the mode register 205-a, whether a write link ECC MBE fault has occurred, where the ECC MBE fault may indicate that an ECC of the memory system 110 detected two or more single bit errors per ECC code word (e.g., payload or mission data) that may not be corrected by the ECC. The memory system 110 may also track, via OP[1] of the mode register 205-a, whether a write link EDC MBE or SBE fault has occurred, where the EDC MBE or SBE fault may indicate that any errors (e.g., single-bit or multi-bit) have been detected.

In some examples, the memory system 110 may track, via OP[2] of the mode register 205-a, whether a write link ECC SBE correction fault has occurred, where the write link ECC SBE correction may indicate that an ECC engine of the memory system 110 attempted to correct an SBE (e.g., whether or not the SBE correction was successful). The memory system 110 may track, via OP[3] of the mode register 205-a, whether an on-die ECC MBE fault has occurred, where the on-die ECC MBE fault may indicate that an on-die ECC engine has detected an MBE fault. The memory system 110 may track, via OP[4] of the mode register 205-a, whether an on-die ECC and ECS SBE threshold exceeded fault has occurred, where the on-die ECC and ECS SBE threshold fault may indicate that a quantity of on-die SBE corrections has exceeded a threshold quantity. As described herein, write link ECC may refer to ECC operations on data received over channels (e.g., links). On-die ECC may refer to ECC operations performed on data stored in the memory array. A refresh rate may refer to a rate at which the memory system controller 115 of the memory system 110 may perform a refresh operation (e.g., reading and rewriting data).

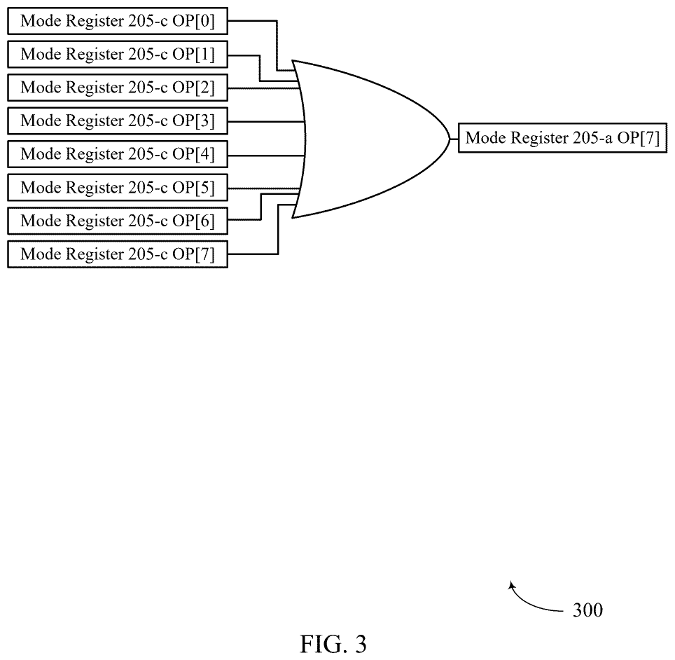

Additionally, the memory system 110 may track, via OP[5] of the mode register 205-a, whether a CMD/ADDR parity fault has occurred, where the CMD/ADDR parity fault may indicate that one or more command and address busses have experienced an error. The memory system 110 may track, via OP[6] of the mode register 205-a, whether a refresh rate change (e.g., MR4 refresh rate) has occurred, where the refresh rate change may indicate that a temperature of the memory system 110 may be outside of a threshold temperature range, which may result in a refresh rate change and thus an MR4 register setting change. In some examples, the memory system 110 may track, via OP[7] of the mode register 205-a, a sum of the operands of a second mode register (e.g., a mode register 205-c), where the sum of the operands of the second mode register may indicate whether any faults tracked by the second mode register have occurred in the memory system. Techniques to sum the operands of the mode register 205-c may further described herein with reference to FIG. 3.

In some cases, the memory system 110 may drive the alert output 215 in response to any operand of the mode register 205-a being set to the high value (e.g., ‘1’, using an OR gate). However, in some examples, a user may identify one or more faults of the mode register 205-a for which the user does not want the memory system 110 to drive an alert output 215. Accordingly, the memory system 110 may include a mode register 205-b (e.g., a fault mode register) to control the alert output 215 in response to detection of a fault.

For example, the memory system 110 may maintain the mode register 205-b, where each function of the mode register 205-b may correspond to the functions of the mode register 205-a. In such examples, the memory system 110 may designate the mode register 205-b as write-only or as read and write (RW), where the mode register 205-b may control which registered faults (e.g., faults included in the mode register 205-a) may affect a status of the alert output 215.

In accordance with the techniques described herein, the host system 105 (e.g., a user of the host system 105) may transmit a mode register write (MRW) command to write a value to an operand (e.g., an operand corresponding to a fault) of the mode register 205-b, thereby instructing the memory system 110 whether or not to drive the alert output 215 in response to a function detecting the corresponding fault. In this way, the user (e.g., via the host system 105), may dynamically select which faults, tracked by the mode register 205-a, trigger the alert output 215.

Similar to the mode register 205-a, the operands of the mode register 205-b may assume two values, a high value (e.g., ‘1’) or a low value (e.g., ‘0’ or default value), where the memory system 110 may maintain the values of the operands of the mode register 205-b as the default value until the memory system 110 receives a MRW command to set the operands to the high value. In some examples, the host system 105 may write the operands of the mode register 205-b when the memory system 110 (e.g., the DRAM) is in an idle state and no data is being driven to, or from, the memory system 110. Table 2 provides an illustrative example of the mode register 205-b (e.g., a fault mode register).

TABLE 2

| | Register | | |
|---|---|---|---|
| Function | Type | Operand | Data |
| PRAC limit exceeded | Write | OP[0] | 0_{B}: Fault does not |
| | | | affect alert output |
| | | | 1_{B}: Fault affects alert |
| | | | output |
| Write link ECC MBE fault/Write | Write | OP[1] | 0_{B}: Fault does not |
| link EDC SBE/MBE fault | | | affect alert output |
| | | | 1_{B}: Fault affects alert |
| | | | output |
| Write link ECC SBE correction | Write | OP[2] | 0_{B}: Fault does not |
| attempted | | | affect alert output |
| | | | 1_{B}: Fault affects alert |
| | | | output |
| On-die ECC MBE fault | Write | OP[3] | 0_{B}: Fault does not |
| | | | affect alert output |
| | | | 1_{B}: Fault affects alert |
| | | | output |
| On-die ECC ECS SBE threshold | Write | OP[4] | 0_{B}: Fault does not |
| exceeded | | | affect alert output |
| | | | 1_{B}: Fault affects alert |
| | | | output |
| CMD/ADDR parity fault | Write | OP[5] | 0_{B}: Fault does not |
| | | | affect alert output |
| | | | 1_{B}: Fault affects alert |
| | | | output |
| MR4 refresh rate change | Write | OP[6] | 0B: Fault does not |
| detected | | | affect alert output |
| | | | 1_{B}: Fault affects alert |
| | | | output |
| Sum of FMR2 OP[7:0] | Write | OP[7] | 0_{B}: Fault does not |
| | | | affect alert output |
| | | | 1_{B}: Fault affects alert |
| | | | output |

In some examples, when the operands of the mode register 205-b are written to (e.g., set), the memory system 110 may reset the value of the operands of the mode register 205-b to the default values when the memory system 110 receives and applies a reset command or a power source is removed from the memory system 110. That is, the memory system 110 may retain the set values of the operands until the reset command is applied or power is removed (e.g., or the memory system 110 receives a MRW command to rewrite the operands to a different state). In some examples, the memory system 110 may reset the values of the operands to the default values during an active read. For example, the memory system 110 may reset the operands of the mode register 205-b in response to receiving a MRR command directed to the mode register 205-a, in response to receiving a MRR command directed to the mode register 205-b, or both. In some examples, the memory system 110 may reset the values of the operands to the default values based on expiration of a timer (e.g., after a time offset or clock delay following a MRW command to set the operands to the mode registers 205, after a time offset following the alert output 215 being driven, or both).

As illustrated in Table 2, an operand having the default value (e.g., 0) may indicate for the memory system 110 to refrain from driving the alert output 215 in response to detecting the corresponding fault, and an operand having the high value (e.g., 1) may indicate for the memory system 110 to drive the alert output 215 in response to detecting the corresponding fault. In some examples, the mode register 205-b may include one or more additional operands indicating for the memory system 110 to drive the alert output 215 if any operand of the mode register 205-a is set (e.g., any fault tracked by the mode register 205-a is detected), if a subset of the operands of the mode register 205-a are set, or both.

In some cases, an operand of the mode register 205-b may control the alert output 215 for a single operand of the mode register 205-a. For example, as is shown in Table 2, OP[0] of mode register 205-b controls the alert output 215 for OP[0] of mode register 205-a. In some cases, an operand of the mode register 205-b may control the alert output 215 for two or more operands of the mode register 205-a. For example, an OP[8] (not shown) of mode register 205-b may control the alert output 215 for OP[0] through OP[3] of the mode register 205-a, while an OP[9] (not shown) of the mode register 205-b may control the alert output 215 for OP[4] through OP[7] of the mode register 205-a. Similarly, an operand of the mode register 205-b may control the alert output 215 for all operands of the mode register 205-a, such that OP[8] of mode register 205-b may control the alert output 215 for OP[0] through OP[7] of the mode register 205-a. Additionally, in some cases, a single operand for the mode register 205-a may correspond to (e.g., be controlled by) multiple operands of the mode register 205-b. For example, each of the OP[5] through OP[7] of the mode register 205-b may control the alert output 215 for at least OP[5] of the mode register 205-a.

The memory system 110 may accordingly drive the alert output 215 based on values of the operands in both of the mode register 205-a and the mode register 205-b (e.g., using AND operations corresponding to each entry of the mode register 205-a and the mode register 205-b). For example, the memory system 110 may drive the alert output 215 when both of an operand of the mode register 205-a and a corresponding operand of the mode register 205-b (e.g., or the additional operand of the mode register 205-b) are set to the high value (e.g., when a fault is detected and when an operand of the mode register 205-b corresponding to the fault has been written to the high value). The memory system 110 may refrain from driving the alert output 215 when the fault has not been detected (e.g., the operand of the mode register 205-a is the default value) or when the corresponding operand of the mode register 205-b is the default value (e.g., when the operand has not been written to or has been set or reset to the default value).

As an illustrative example, the memory system 110 may receive a MRW command to set the value of OP[6] of the mode register 205-b to a ‘1’, indicating for the memory system 110 to drive the alert output 215, to the host system 105, in response to detecting a refresh rate change in the memory system 110. Accordingly, if the memory system 110 detects a refresh rate change, the memory system 110 may set OP[6] of the mode register 205-a to a ‘1’, which may trigger the memory system 110 to drive the alert output 215 to the host system 105. In this way, the memory system 110 may drive the alert output 215, asynchronously, in response to fault occurrence. Alternatively, as long as the memory system 110 does not detect the refresh rate change, the memory system 110 may maintain OP[6] of the mode register 205-a as a ‘0’, thereby refraining from driving the alert output 215 to the host system 105.

As another illustrative example, the memory system 110 may receive a MRW command to set the value of OP[6] to a ‘0’, indicating that the corresponding fault (e.g., refresh rate change) does not affect the alert output 215. Accordingly, if the memory system 110 detects a refresh rate change, the memory system 110 may set OP[6] of the mode register 205-a to a ‘1’, but because the value of OP[6] of the mode register 205-b is set to ‘0’, the memory system 110 may refrain from driving the alert output 215 to the host system 105.

To accomplish such functionality, the memory system 110 may perform an AND operation on (e.g., AND together) between each operand of the mode register 205-a and the corresponding operand of the mode register 205-b. Accordingly, the memory system 110 may perform an OR operation on (e.g., OR together) the output of each AND operation. In this way, if any of the operands of the mode register 205-a are set to the high value, indicating that at least one fault tracked by the mode register 205-a has occurred, and a corresponding operand of the mode register 205-b is set to the high value, indicating that the fault affects the alert output 215, the memory system 110 may drive the alert output 215.

As described herein, the memory system 110 may maintain any quantity of mode registers 205 that track faults that have occurred in the memory system 110 and also may maintain a corresponding mode register 205 to indicate whether such faults control the alert output 215. For example, the memory system 110 may maintain (e.g., include, manage, or store) the mode register 205-c (e.g., another read register). Similar to the mode register 205-a, the operands of the mode register 205-c may assume two values, a high value (e.g., ‘1’) or a low value (e.g., ‘0’ or default value), where the memory system 110 may maintain the values of the operands as the default value and update the values of the operands to a high value (e.g., 1) in response to the corresponding fault being detected by the covered function. That is, the operands of the mode register 205-c may default low and may remain low unless a covered function has detected a fault, at which point the memory system 110 may set the associated operand (e.g., register bit) to the high value (e.g., or vice-versa).

In some examples, the memory system 110 may designate (e.g., set the type of) the mode register 205-c as read-only (R). That is, the host system 105 may be unable to write values to the operands of the mode register 205-c, and instead are set by the memory system 110 based on whether the corresponding fault (e.g., function) is detected. That is, the memory system 110 may receive a MRR command from the host system 105 to read the values of one or more operands of the mode register 205-c. In some examples, when the memory system 110 sets the values of the operands of the mode registers to the high value (e.g., ‘1’), the values may remain high (e.g., retain the fault status) until the memory system 110 receives the MRR command from the host system 105 (e.g., the mode register 205-c is read from), the memory system 110 receives a reset command, or a power source of the memory system 110 is removed, at which point the values may be reset to the default values (e.g., low). In some examples, the memory system 110 may reset the values of the operands to the default values based on expiration of a timer (e.g., after a time offset or clock delay following detection of the corresponding faults). In some examples, the faults monitored by the mode register 205-c may be reserved for future use (RFU). Table 3 provides an illustrative example of the mode register 205-c.

TABLE 3

| | | | | |
|---|---|---|---|---|
| | Register | | | |
| Function | Type | Operand | Data | Notes |

| | | | |
|---|---|---|---|
| RFU | Read | OP[0] | 0_{B}: Fault not detected |
| | | | 1_{B}: Fault Detected |
| RFU | Read | OP[1] | 0_{B}: Fault not detected |
| | | | 1_{B}: Fault Detected |
| RFU | Read | OP[2] | 0_{B}: Fault not detected |
| | | | 1_{B}: Fault Detected |
| RFU | Read | OP[3] | 0_{B}: Fault not detected |
| | | | 1_{B}: Fault Detected |
| RFU | Read | OP[4] | 0_{B}: Fault not detected |
| | | | 1_{B}: Fault Detected |
| RFU | Read | OP[5] | 0_{B}: Fault not detected |
| | | | 1_{B}: Fault Detected |
| RFU | Read | OP[6] | 0_{B}: Fault not detected |
| | | | 1_{B}: Fault Detected |
| RFU | Read | OP[7] | 0_{B}: Fault not detected |
| | | | 1_{B}: Fault Detected |

In some examples, as illustrated with reference to Table 3, the entries in the mode register 205-c may be RFU or may be designated as vendor specific, such that one or more operators of the memory system 110 may determine the functions (e.g., faults) of the mode register 205-c. In some aspects, an operand of the mode register 205-a (e.g., OP[7], as illustrated with reference to Table 1) may indicate a sum of operands of the mode register 205-c or an OR operation of operands of the mode register 205-c (e.g., Sum of FMR2 OP[7:0]). Such techniques are described in further detail with reference to FIG. 3.

In some examples, the memory system 110 may include a mode register 205-d (e.g., a fault mode register, a write register) that may control which registered faults (e.g., faults included in the mode register 205-c) may affect a status of the alert output 215. In such examples, the memory system 110 may designate the mode register 205-d as write-only or read and write. Accordingly, the host system 105 (e.g., via the user of the host system 105) may transmit a MRW command to write a value to an operand (e.g., an operand corresponding to a fault) of the mode register 205-d, thereby instructing the memory system 110 whether or not to drive the alert output 215 in response to a function detecting the corresponding fault.

The operands of the mode register 205-d may assume two values, a low value (e.g., ‘0’ or default value) and a high value (e.g., ‘1’), where the memory system 110 may maintain the values of the operands to be the default value until the memory system 110 receives the MRW command to set to the operands to the high value. In some examples, the host system 105 may write to the operands of the mode register 205-d when the memory system 110 (e.g., the DRAM) is in an idle state and no data is being driven to, or from, the memory system 110. Table 4 provides an illustrative example of the mode register 205-d (e.g., a fault mode register).

TABLE 2

| | | | | |
|---|---|---|---|---|
| | Register | | | |
| Function | Type | Operand | Data | Notes |

| | | | |
|---|---|---|---|
| RFU | Write | OP[0] | 0_{B}: Fault does not |
| | | | affect alert output |
| | | | 1_{B}: Fault affects alert |
| | | | output |
| RFU | Write | OP[1] | 0_{B}: Fault does not |
| | | | affect alert output |
| | | | 1_{B}: Fault affects alert |
| | | | output |
| RFU | Write | OP[2] | 0_{B}: Fault does not |
| | | | affect alert output |
| | | | 1_{B}: Fault affects alert |
| | | | output |
| RFU | Write | OP[3] | 0_{B}: Fault does not |
| | | | affect alert output |
| | | | 1_{B}: Fault affects alert |
| | | | output |
| RFU | Write | OP[4] | 0_{B}: Fault does not |
| | | | affect alert output |
| | | | 1_{B}: Fault affects alert |
| | | | output |
| RFU | Write | OP[5] | 0_{B}: Fault does not |
| | | | affect alert output |
| | | | 1_{B}: Fault affects alert |
| | | | output |
| RFU | Write | OP[6] | 0_{B}: Fault does not |
| | | | affect alert output |
| | | | 1_{B}: Fault affects alert |
| | | | output |
| RFU | Write | OP[7] | 0_{B}: Fault does not |
| | | | affect alert output |
| | | | 1_{B}: Fault affects alert |
| | | | output |

The functions of the mode register 205-d may correspond to the functions of the mode register 205-c (e.g., RFU until the corresponding functions of the mode register 205-c are defined). In some examples, when the operands of the mode register 205-d are written to (e.g., set), the memory system 110 may reset the values of the operands of the mode register 205-d to the default values in response to reception of a reset command, in response to a power source being removed from the memory system 110. That is, the memory system 110 may retain the set values of the operands until the reset command is applied or power is removed (e.g., or the memory system 110 receives a write command to rewrite the operands to a different state). In some examples, the memory system 110 may reset the values of the operands to the default values during an active read command. For example, the memory system 110 may reset the values of the operands of the mode register 205-d in response to a MRR command directed to the mode register 205-c, in response to a MRR command directed to the mode register 205-d, or both. In some examples, the memory system 110 may reset the values of the operands to the default values based on expiration of a timer (e.g., after a time offset following a MRW command to set the operands of the mode registers 205, after a time offset from driving the alert output 215, or both).

In some examples, an operand of the mode register 205-d having the default value may indicate for the memory system 110 to refrain from driving the alert output 215 in response to detecting the corresponding fault, and an operand of the mode register 205-d having the high value may indicate for the memory system 110 to drive the alert output 215 in response to detecting the corresponding fault. In some examples, the mode register 205-d may include one or more additional operands indicating for the memory system 110 to drive the alert output 215 if any fault tracked by the mode register 205-c is detected, if a subset of the faults tracked by the mode register 205-c are detected, or both.

The memory system 110 may accordingly drive the alert output 215 based on values of the operands in both of the mode register 205-c and the mode register 205-d (e.g., using AND operations corresponding to each entry of the mode register 205-c and the mode register 205-d). For example, the memory system 110 may drive the alert output 215 when both of an operand of the mode register 205-c and a corresponding operand of the mode register 205-d (e.g., or the additional operand of the mode register 205-b) are the high value (e.g., when a fault is detected and when an operand of the mode register 205-d corresponding to the fault has been written to the high value). The memory system 110 may refrain from driving the alert output 215 when the fault has not been detected (e.g., the operand of the mode register 205-c is the default value) or when the corresponding operand of the mode register 205-d is the default value (e.g., when the operand has not been written to or has been set or reset to the default value).

As described herein, OP[7] of the mode register 205-b may correspond to a sum of the operands (e.g., OP[0]-OP[7]) of the mode register 205-c. In such examples, the value of OP[7] of the mode register 205-b may override the operands of the mode register 205-d. That is, if the value of OP[7] of the mode register 205-b is the default value (e.g., 0, low), the memory system 110 may not drive the alert output 215 in response to detecting any faults of the mode register 205-c (e.g., regardless of the corresponding value of the corresponding operand of the mode register 205-d).

In some examples, if the memory system 110 detects a fault and the host system 105 desires to receive the alert output 215 in response to detecting the fault (e.g., a first operand of mode register 205-a or 205-c is ‘1’ and the corresponding operand of the mode register 205-b or 205-d is ‘1’), the memory system 110 may drive the alert output 215 within a threshold quantity of time (e.g., timing parameter) from detecting the fault. In some examples, the threshold quantity of time may be associated with the mode register 205-a and the mode register 205-c, where the threshold quantity of time may be derived from a worst case delay of all the fault conditions tracked by the mode registers 205-a and 205-c. Alternatively, the memory system 110 may maintain two threshold quantity of times (e.g., two timing parameters). In such examples, a first threshold quantity of time may be associated with the mode register 205-a and indicate the worst case delay for the fault conditions tracked by the mode register 205-a, while a second threshold quantity of time may be associated with the mode register 205-c and indicate the worst case delay for the fault conditions tracked by the mode register 205-c. Alternatively, the memory system 110 may maintain a respective threshold quantity of time for each fault tracked by the mode registers 205-a and 205-c, where the respective threshold quantity of time for each fault may be based on a worst case delay associated with the fault. Accordingly, the memory system 110 may output the alert output 215 within the threshold quantity of time from detecting the fault.

In some examples, in response to driving the alert output 215 to the memory system (e.g., in response to detecting a fault in the memory system), the memory system 110 may clear (e.g., deactivate) the alert output 215 in response to receiving a MRR command (e.g., for an operand corresponding to a detected fault on the mode register 205-a and/or the mode register 205-b), in response to receiving a reset command, or in response to a power source of the memory system 110 being removed. In some examples, the memory system 110 may deactivate the alert output 215 based on expiration of a timer (e.g., after a time offset or clock delay following a time at which the memory system 110 drives the alert output 215 or after a time offset).

In some examples, the memory system 110, the host system 105, or both may maintain a fault to alert timing table to determine a time between fault detection and reception of a valid MRR command at the memory system 110, to determine a time between reception of a valid MRR command and clearing the alert output 215 at the memory system 110, or both. Table 5 provides an illustrative example of the fault to alert timing table.

TABLE 5

| | | | | |
|---|---|---|---|---|
| | | | Valid MRR | |
| | | Detection to | to Alert | |
| Function | Operand | Valid MRR | Output | Notes |

| | | | |
|---|---|---|---|
| PRAC limit exceeded | FMR1 | Threshold X | Threshold X |
| | OP[0] | | |
| Write link ECC MBE | FMR1 | Threshold X | Threshold X |
| fault/Write link EDC | OP[1] | | |
| SBE/MBE fault | | | |
| Write link ECC SBE | FMR1 | Threshold X | Threshold X |
| correction attempted | OP[2] | | |
| On-die ECC MBE fault | FMR1 | Threshold X | Threshold X |
| | OP[3] | | |
| On-die ECC ECS SBE | FMR1 | Threshold X | Threshold X |
| threshold exceeded | OP[4] | | |
| CMD/ADDR parity fault | FMR1 | Threshold X | Threshold X |
| | OP[5] | | |
| MR4 refresh rate change | FMR1 | Threshold X | Threshold X |
| detected | OP[6] | | |
| Sum of FMR2 OP[7:0] | FMR1 | Threshold X | Threshold X |
| | OP[7] | | |
| RFU | FMR2 | Threshold X | Threshold X |
| | OP[0] | | |
| RFU | FMR2 | Threshold X | Threshold X |
| | OP[1] | | |
| RFU | FMR2 | Threshold X | Threshold X |
| | OP[2] | | |
| RFU | FMR2 | Threshold X | Threshold X |
| | OP[3] | | |
| RFU | FMR2 | Threshold X | Threshold X |
| | OP[4] | | |
| RFU | FMR2 | Threshold X | Threshold X |
| | OP[5] | | |
| RFU | FMR2 | Threshold X | Threshold X |
| | OP[6] | | |
| RFU | FMR2 | Threshold X | Threshold X |
| | OP[7] | | |

As illustrated with reference to Table 5, each entry in the fault to alert timing table may correspond to a fault (e.g., operand) of the mode register 205-a and a fault (e.g., operand) of the mode register 205-c. Accordingly, the memory system 110 may receive a MRR command to read an operand of the mode register 205 (e.g., corresponding to a fault) within the corresponding threshold time (set in the third column of Table 5) from when the corresponding fault has been detected. Additionally, the memory system 110 may deactivate the alert output 215 after the threshold time (set in the fourth column) elapses (e.g., after receiving the MRR command for the corresponding operand). That is, the memory system 110 may delay deactivating the alert output 215 until the threshold time (set in the fourth column of table 5) has elapsed from reception of a valid MRR command. In some examples, a time for clearing a fault from the alert output 215 may depend on the type of fault (e.g., each fault may have a different threshold time).

FIG. 3 shows an example of a circuit diagram 300 that supports alert signaling in memory systems in accordance with examples as disclosed herein. The circuit diagram 300 may implement or may be implemented by aspects of the system 100 or the circuit diagram 200. For example, the circuit diagram 300 may be implemented in a memory system 110, which may be an example of a memory system 110 as described with reference to FIG. 1. The techniques described in the context of the circuit diagram 300 may enable the memory system to link OP[7] of the mode register 205-a to a summation of the operands (e.g., OP[0]-OP[7]) of the mode register 205-c.

In some examples, as described with reference to FIG. 2, a memory system 110 may include one or more mode registers 205. For example, the memory system may include a mode register 205-a and a mode register 205-c, each including one or more functions that correspond to faults in the memory system 110. In some examples, operands of the mode register 205-a and the mode register 205-c may have a default value (e.g., 0) if the corresponding fault has not occurred in the memory system 110, and may have a high value (e.g., 1) if the corresponding fault has occurred in the memory system 110.

As described herein, OP[7] of the mode register 205-a may indicate a sum of each operand of the mode register 205-c. For example, if any operands of the mode register 205-c are set to the high value (e.g., if any faults listed in the mode register 205-c are detected), the memory system 110 may set OP[7] of the mode register 205-a to the high value. Alternatively, if no operands of the mode register 205-c are set to the high value (e.g., if all operands of the mode register 205-c are the default value), the memory system 110 may maintain OP[7] of the mode register 205-a to the default value.

To accomplish such functionality, the memory system 110 may perform an OR operation on (e.g., OR together) each operand of the mode register 205-c, where the output of the OR operation is OP[7] of the mode register 205-a. In this way, if any of the operands of the mode register 205-c are set to the high value, indicating that at least one fault tracked by the mode register 205-c has occurred, the first operand of the mode register 205-a may be set to the high value.

Such techniques may reduce a total quantity of read commands used by the host system 105 to identify a fault in the memory system 110. For example, if no operands of the mode register 205-c are set to the high value and the first operand of the mode register 205-a is the default value, the host system 105 may identify that no faults tracked by the mode register 205-c have occurred in the memory system 110 without using a MRR command to read each operand of the mode register 205-c.

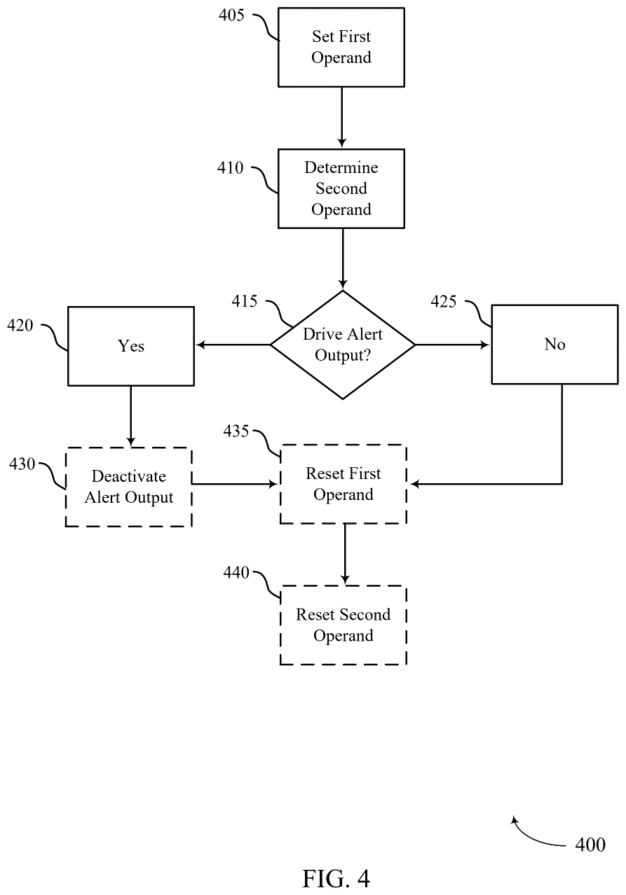

FIG. 4 shows an example of a process flow 400 that supports alert signaling in memory systems in accordance with examples as disclosed herein. The process flow 400 may implement or may be implemented by aspects of the system 100, the circuit diagram 200, or the circuit diagram 300. For example, the process flow 400 may be implemented by the memory system 110 (e.g., memory system controller 140 or memory device 145) as described with reference to FIG. 1. The techniques described in the context of the process flow 400 may enable the memory system 110 to determine whether to drive an alert output in response to detecting a fault in the memory system 110.

In the following description of the process flow 400, the operations may occur in a different order than the example order shown and, in some examples, may be performed by one or more different devices other than those described as examples. Some operations also may be omitted from the process flow 400, and other operations may be added to the process flow 400. Further, although some operations may be shown to occur at different times for discussion purposes, these operations may actually occur at the same time.

At 405, a memory system 110 may set a first operand of a first register (e.g., a first mode register, a first fault mode register, the mode register 205-a, or the mode register 205-c) to a value (e.g., either a ‘0’ or a ‘1’). For example, the memory system 110 may determine whether a fault corresponding to the first operand has occurred in the memory system 110, where the value of the first operand may indicate whether or not the fault occurred. Accordingly, if the memory system 110 detects the fault, the memory system 110 may set the value of the first operand to a ‘1’, while if the memory system 110 does not detect the fault, the memory system 110 may maintain the value of the first operand at ‘0’, or vice versa.

At 410, the memory system 110 may determine a value of second operand of a second register (e.g., a second mode register, a second fault mode register, the mode register 205-b, or the mode register 205-d), where the second operand of the second register may correspond to the first operand of the first register. As described herein, the value of the second operand may indicate whether an alert output (e.g., the alert output 215) is driven based on the fault, corresponding to the first operand, occurring in the memory system 110.

For example, the memory system 110 may receive a MRW command (e.g., from the host system 105) to write the value of the second operand, and the memory system 110 may determine the value of the second operand based on receiving the MRW command. In some examples, the memory system 110 may receive the MRW command based on the memory system 110 being in an idle mode of operation. Accordingly, the host system 105 may transmit the MRW command to write a value of ‘1’ to the second operand of the second mode register, thereby indicating that the memory system 110 is to drive the alert output in response to the fault occurring in the memory system 110. Alternatively, the host system 105 may transmit the MRW command to write a value of ‘0’ to the second operand of the second mode register, thereby indicating that the memory system 110 is to refrain from driving the alert output in response to the fault occurring in the memory system 110.

At 415, the memory system 110 may determine whether to drive the alert output based on the respective values of the first operand and the second operand. For example, at 420, if the value of the first operand indicates that the fault has occurred in the memory system 110 and the value of the second operand indicates that the alert output is driven based on the fault occurring, the memory system 110 may drive the alert output. Alternatively, at 425, if the value of the first operand indicates that the fault has not occurred in the memory system and/or the value of the second operand indicates that the alert output is not driven based on the fault occurring, the memory system 110 may refrain from driving the alert output.

In some examples, at 430, the memory system 110 may deactivate the alert output in response to driving the alert output at 420. For example, the memory system 110 may deactivate the alert output based on receiving a MRR command to read the value of the first operand of the first register, based on receiving a reset command, based on a power source of the memory system 110 being removed, based on expiration of a timer, or some combination thereof.

In some examples, at 435, the memory system 110 may reset the first operand (e.g., to a default value). For example, the memory system 110 may reset the first operand to the default value in response to receiving a MRR command to read the first operand (e.g., within a threshold time of driving the alert output or within a threshold time of when the fault occurred in the memory system, where the threshold time depends on the type of fault). Additionally, or alternatively, the memory system 110 may reset the first operand to the default value in response to receiving a reset command and/or in response to a power source of the memory system 110 being removed. In some other examples, at 435, the memory system 110 may reset the first operand in response to expiration of a timer (e.g., clock delay).

In some examples, at 440, the memory system 110 may reset the second operand (e.g., to a default value). For example, the memory system 110 may reset the second operand to the default value in response to receiving a reset command and/or in response to a power source of the memory system 110 being removed. In some examples, at 440, the memory system 110 may reset the second operand (e.g., the second mode register) in response to a MRR command directed to the first mode register, in response to a MRR command directed to the second mode register, or both. In some other examples, at 440, the memory system 110 may reset the second operand in response to expiration of a timer (e.g., clock delay).

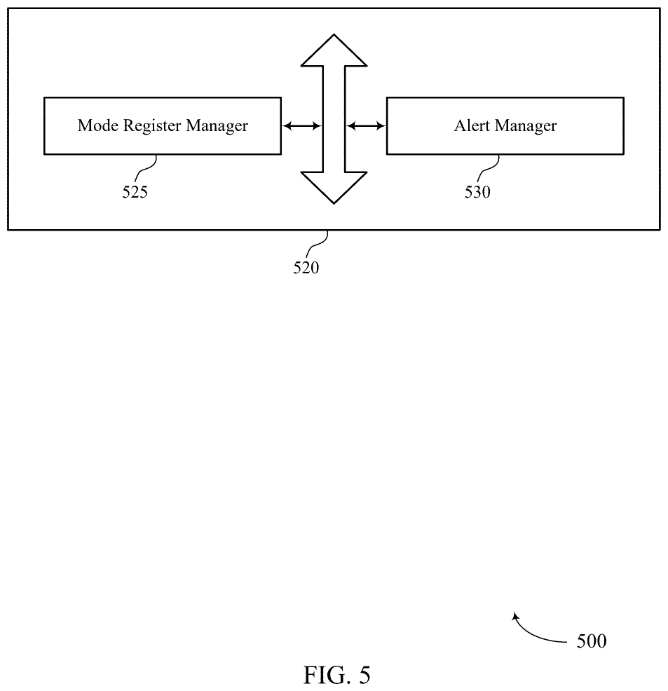

FIG. 5 shows a block diagram 500 of a memory system 520 that supports alert signaling in memory systems in accordance with examples as disclosed herein. The memory system 520 may be an example of aspects of a memory system as described with reference to FIGS. 1 through 4. The memory system 520, or various components thereof, may be an example of means for performing various aspects of alert signaling in memory systems as described herein. For example, the memory system 520 may include a mode register manager 525 an alert manager 530, or any combination thereof. Each of these components, or components of subcomponents thereof (e.g., one or more processors, one or more memories), may communicate, directly or indirectly, with one another (e.g., via one or more buses).

The mode register manager 525 may be configured as or otherwise support a means for setting a first operand of a first register to a value, where the first operand indicates whether a fault has occurred in the memory system. In some examples, the mode register manager 525 may be configured as or otherwise support a means for determining a value of a second operand of a second register, where the second operand indicates whether an alert output is driven based at least in part on the fault occurring in the memory system. The alert manager 530 may be configured as or otherwise support a means for determining whether to drive the alert output based at least in part on the value of the first operand and the value of the second operand.

In some examples, to support determining whether to drive the alert output, the alert manager 530 may be configured as or otherwise support a means for refraining from driving the alert output based at least in part on the value of the first operand indicating that the fault has not occurred in the memory system.

In some examples, to support determining whether to drive the alert output, the alert manager 530 may be configured as or otherwise support a means for refraining from driving the alert output based at least in part on the value of the second operand indicating that the alert output is not driven based at least in part on the fault occurring in the memory system.

In some examples, to support determining whether to drive the alert output, the alert manager 530 may be configured as or otherwise support a means for driving the alert output based at least in part on the value of the first operand indicating that the fault has occurred and on the value of the second operand indicating that the alert output is driven based at least in part on the fault occurring.

In some examples, the alert manager 530 may be configured as or otherwise support a means for deactivating the alert output based at least in part on receiving a MRR command to read the value of the first operand of the first register, on receiving a reset command, on a power source of the memory system being removed, on expiration of a timer, or a combination thereof.

In some examples, the alert manager 530 may be configured as or otherwise support a means for deactivating the alert output within a threshold quantity of time from reception of the mode register read command.

In some examples, the mode register manager 525 may be configured as or otherwise support a means for receiving a MRR command to read the first operand of the first register. In some examples, the mode register manager 525 may be configured as or otherwise support a means for resetting the first operand of the first register to a default value based at least in part on receiving the MRR command.

In some examples, the MRR command is received within a first threshold quantity of time from driving the alert output. In some examples, the first threshold quantity of time is based at least in part on a type of the fault.

In some examples, the MRR command is received within a first threshold quantity of time from the fault occurring in the memory system. In some examples, the first threshold quantity of time is based at least in part on a type of the fault.

In some examples, the mode register manager 525 may be configured as or otherwise support a means for resetting the first operand of the first register to a default value based at least in part on receiving a reset command, on a power source of the memory system being removed, on expiration of a timer, or a combination thereof.

In some examples, the mode register manager 525 may be configured as or otherwise support a means for receiving, from a host device, a MRW command to write the value of the second operand of the second register, where determining the value of the second operand is based at least in part on receiving the MRW command.

In some examples, the memory system is operating in an idle mode of operation and receiving the MRW command is based at least in part on the memory system operating in the idle mode of operation.

In some examples, the mode register manager 525 may be configured as or otherwise support a means for resetting the second operand of the second register to a default value based at least in part on receiving a reset command, on a power source of the memory system being removed, on expiration of a timer, on receiving a MRR command directed to the first register, on receiving a MRR command directed to the second register, or a combination thereof.

In some examples, the fault includes one of a PRAC limit exceeded, a write link ECC MBE fault, a write link EDC SBE fault, a write link EDC MBE fault, a write link ECC SBE attempt fault, an on-die ECC MBE fault, an on-die ECS SBE threshold fault, a command address parity fault, a refresh rate change, or any combination thereof.

In some examples, the first operand of the first register indicates whether at least one operand of a third register has been set to a first value.

In some examples, the second operand of the second register corresponds to the first operand of the first register.

In some examples, the second operand of the second register corresponds to a plurality of operands of the first register.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

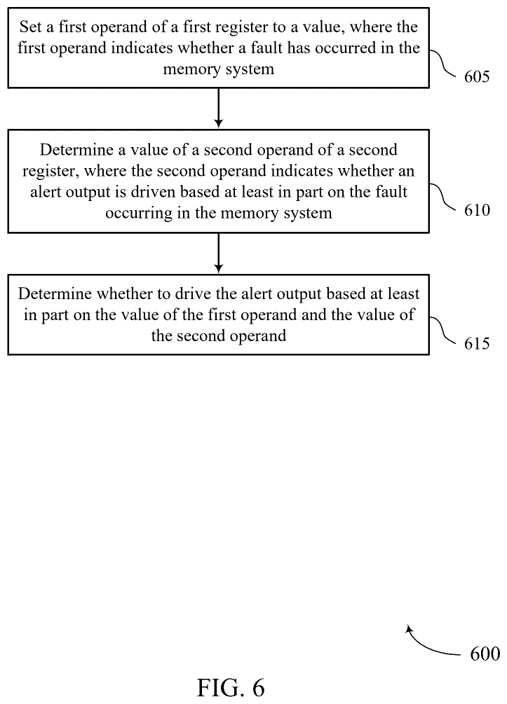

FIG. 6 shows a flowchart illustrating a method 600 that supports alert signaling in memory systems in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include setting a first operand of a first register to a value, where the first operand indicates whether a fault has occurred in the memory system. In some examples, aspects of the operations of 605 may be performed by a mode register manager 525 as described with reference to FIG. 5.

At 610, the method may include determining a value of a second operand of a second register, where the second operand indicates whether an alert output is driven based at least in part on the fault occurring in the memory system. In some examples, aspects of the operations of 610 may be performed by a mode register manager 525 as described with reference to FIG. 5.

At 615, the method may include determining whether to drive the alert output based at least in part on the value of the first operand and the value of the second operand. In some examples, aspects of the operations of 615 may be performed by an alert manager 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for setting a first operand of a first register to a value, where the first operand indicates whether a fault has occurred in the memory system; determining a value of a second operand of a second register, where the second operand indicates whether an alert output is driven based at least in part on the fault occurring in the memory system; and determining whether to drive the alert output based at least in part on the value of the first operand and the value of the second operand.

Aspect 2: The method, apparatus, or non-transitory computer-readable medium of aspect 1, where determining whether to drive the alert output includes operations, features, circuitry, logic, means, or instructions, or any combination thereof for refraining from driving the alert output based at least in part on the value of the first operand indicating that the fault has not occurred in the memory system.

Aspect 3: The method, apparatus, or non-transitory computer-readable medium of any of aspects 1 through 2, where determining whether to drive the alert output includes operations, features, circuitry, logic, means, or instructions, or any combination thereof for refraining from driving the alert output based at least in part on the value of the second operand indicating that the alert output is not driven based at least in part on the fault occurring in the memory system.

Aspect 4: The method, apparatus, or non-transitory computer-readable medium of any of aspects 1 through 3, where determining whether to drive the alert output includes operations, features, circuitry, logic, means, or instructions, or any combination thereof for driving the alert output based at least in part on the value of the first operand indicating that the fault has occurred and on the value of the second operand indicating that the alert output is driven based at least in part on the fault occurring.

Aspect 5: The method, apparatus, or non-transitory computer-readable medium of aspect 4, further including operations, features, circuitry, logic, means, or instructions, or any combination thereof for deactivating the alert output based at least in part on receiving a MRR command to read the value of the first operand of the first register, on receiving a reset command, on a power source of the memory system being removed, on expiration of a timer, or a combination thereof.

Aspect 6: The method, apparatus, or non-transitory computer-readable medium of aspect 5, further including operations, features, circuitry, logic, means, or instructions, or any combination thereof for deactivating the alert output within a threshold quantity of time from reception of the mode register read command.

Aspect 7: The method, apparatus, or non-transitory computer-readable medium of any of aspects 4 through 5, further including operations, features, circuitry, logic, means, or instructions, or any combination thereof for receiving a MRR command to read the first operand of the first register and resetting the first operand of the first register to a default value based at least in part on receiving the MRR command.

Aspect 8: The method, apparatus, or non-transitory computer-readable medium of aspect 7, where the MRR command is received within a first threshold quantity of time from driving the alert output and the first threshold quantity of time is based at least in part on a type of the fault.

Aspect 9: The method, apparatus, or non-transitory computer-readable medium of any of aspects 7 through 8, where the MRR command is received within a first threshold quantity of time from the fault occurring in the memory system and the first threshold quantity of time is based at least in part on a type of the fault.

Aspect 10: The method, apparatus, or non-transitory computer-readable medium of any of aspects 1 through 9, further including operations, features, circuitry, logic, means, or instructions, or any combination thereof for resetting the first operand of the first register to a default value based at least in part on receiving a reset command, on a power source of the memory system being removed, on expiration of a timer, or a combination thereof.

Aspect 11: The method, apparatus, or non-transitory computer-readable medium of any of aspects 1 through 10, further including operations, features, circuitry, logic, means, or instructions, or any combination thereof for receiving, from a host device, a MRW command to write the value of the second operand of the second register, where determining the value of the second operand is based at least in part on receiving the MRW command.

Aspect 12: The method, apparatus, or non-transitory computer-readable medium of aspect 11, where the memory system is operating in an idle mode of operation and receiving the MRW command is based at least in part on the memory system operating in the idle mode of operation.

Aspect 13: The method, apparatus, or non-transitory computer-readable medium of any of aspects 1 through 12, further including operations, features, circuitry, logic, means, or instructions, or any combination thereof for resetting the second operand of the second register to a default value based at least in part on receiving a reset command, on a power source of the memory system being removed, on expiration of a timer, on receiving a MRR command directed to the first register, on receiving a MRR command directed to the second register, or a combination thereof.

Aspect 14: The method, apparatus, or non-transitory computer-readable medium of any of aspects 1 through 13, where the fault includes one of a PRAC limit exceeded, a write link ECC MBE fault, a write link EDC SBE fault, a write link EDC MBE fault, a write link ECC SBE attempt fault, an on-die ECC MBE fault, an on-die ECS SBE threshold fault, a command address parity fault, a refresh rate change, or any combination thereof.

Aspect 15: The method, apparatus, or non-transitory computer-readable medium of any of aspects 1 through 14, where the first operand of the first register indicates whether at least one operand of a third register has been set to a first value.

Aspect 16: The method, apparatus, or non-transitory computer-readable medium of any of aspects 1 through 15, where the second operand of the second register corresponds to the first operand of the first register.

Aspect 17: The method, apparatus, or non-transitory computer-readable medium of any of aspects 1 through 16, where the second operand of the second register corresponds to a plurality of operands of the first register.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
set a first operand of a first register to a value, wherein the first operand indicates whether a fault has occurred in the memory system;
determine a value of a second operand of a second register, wherein the second operand indicates whether an alert output is driven based at least in part on the fault occurring in the memory system; and
determine whether to drive the alert output based at least in part on the value of the first operand and the value of the second operand.

2. The memory system of claim 1, wherein, to determine whether to drive the alert output, the processing circuitry is configured to cause the memory system to:
refrain from driving the alert output based at least in part on the value of the first operand indicating that the fault has not occurred in the memory system.

3. The memory system of claim 1, wherein, to determine whether to drive the alert output, the processing circuitry is configured to cause the memory system to:
refrain from driving the alert output based at least in part on the value of the second operand indicating that the alert output is not driven based at least in part on the fault occurring in the memory system.

4. The memory system of claim 1, wherein, to determine whether to drive the alert output, the processing circuitry is configured to cause the memory system to:
drive the alert output based at least in part on the value of the first operand indicating that the fault has occurred and on the value of the second operand indicating that the alert output is driven based at least in part on the fault occurring.

5. The memory system of claim 4, wherein the processing circuitry is further configured to cause the memory system to:
deactivate the alert output based at least in part on receiving a mode register read command to read the value of the first operand of the first register, on receiving a reset command, on a power source of the memory system being removed, on expiration of a timer, or a combination thereof.

6. The memory system of claim 5, wherein the processing circuitry is further configured to cause the memory system to:
deactivate the alert output within a threshold quantity of time from reception of the mode register read command.

7. The memory system of claim 4, wherein the processing circuitry is further configured to cause the memory system to:
receive a mode register read command to read the first operand of the first register; and
reset the first operand of the first register to a default value based at least in part on receiving the mode register read command.

8. The memory system of claim 7, wherein:
the mode register read command is received within a first threshold quantity of time from driving the alert output, and
the first threshold quantity of time is based at least in part on a type of the fault.

9. The memory system of claim 7, wherein:
the mode register read command is received within a first threshold quantity of time from the fault occurring in the memory system, and
the first threshold quantity of time is based at least in part on a type of the fault.

10. The memory system of claim 1, wherein the processing circuitry is further configured to cause the memory system to:
reset the first operand of the first register to a default value based at least in part on receiving a reset command, on a power source of the memory system being removed, on expiration of a timer, on receiving a mode register read command directed to the first register, or a combination thereof.

11. The memory system of claim 1, wherein the processing circuitry is further configured to cause the memory system to:
receive, from a host device, a mode register write command to write the value of the second operand of the second register, wherein determining the value of the second operand is based at least in part on receiving the mode register write command.

12. The memory system of claim 11, wherein the memory system is operating in an idle mode of operation and receiving the mode register write command is based at least in part on the memory system operating in the idle mode of operation.

13. The memory system of claim 1, wherein the processing circuitry is further configured to cause the memory system to:
reset the second operand of the second register to a default value based at least in part on receiving a reset command, on a power source of the memory system being removed, on receiving a mode register read command directed to the first register, on receiving a mode register read command directed to the second register, on expiration of a timer, or a combination thereof.

14. The memory system of claim 1, wherein the fault comprises one of a per row activation (PRAC) limit exceeded, a write link error correction code (ECC) multi-bit error (MBE) fault, a write link error detection code (EDC) single bit error (SBE) fault, a write link EDC MBE fault, a write link ECC SBE attempt fault, an on-die ECC MBE fault, an on-die error correction and scrub (ECS) SBE threshold fault, a command address parity fault, a refresh rate change, or any combination thereof.

15. The memory system of claim 1, wherein the first operand of the first register indicates whether at least one operand of a third register has been set to a first value.

16. The memory system of claim 1, wherein:
the second operand of the second register corresponds to the first operand of the first register.

17. The memory system of claim 1, wherein:
the second operand of the second register corresponds to a plurality of operands of the first register.

18. A non-transitory computer-readable medium storing code, the code comprising instructions executable by one or more processors to:
set a first operand of a first register to a value, wherein the first operand indicates whether a fault has occurred in a memory system;
determine a value of a second operand of a second register, wherein the second operand indicates whether an alert output is driven based at least in part on the fault occurring in the memory system; and
determine whether to drive the alert output based at least in part on the value of the first operand and the value of the second operand.

19. The non-transitory computer-readable medium of claim 18, wherein the instructions to determine whether to drive the alert output are executable by the one or more processors to:
refrain from driving the alert output based at least in part on the value of the first operand indicating that the fault has not occurred in the memory system.

20. The non-transitory computer-readable medium of claim 18, wherein the instructions to determine whether to drive the alert output are executable by the one or more processors to:
refrain from driving the alert output based at least in part on the value of the second operand indicating that the alert output is not driven based at least in part on the fault occurring in the memory system.

21. The non-transitory computer-readable medium of claim 18, wherein the instructions to determine whether to drive the alert output are executable by the one or more processors to:
drive the alert output based at least in part on the value of the first operand indicating that the fault has occurred and on the value of the second operand indicating that the alert output is driven based at least in part on the fault occurring.

22. A method at a memory system, comprising:
setting a first operand of a first register to a value, wherein the first operand indicates whether a fault has occurred in the memory system;
determining a value of a second operand of a second register, wherein the second operand indicates whether an alert output is driven based at least in part on the fault occurring in the memory system; and
determining whether to drive the alert output based at least in part on the value of the first operand and the value of the second operand.
